(19) United States
(12) Patent Application Publication
(10) Pub. No.: US 2023/0098298 A1
(43) Pub. Date: Mar. 30, 2023

(54) SCALABLE SECURE SPEED NEGOTIATION FOR TIME-SENSITIVE NETWORKING DEVICES

(71) Applicant: Intel Corporation, Santa Clara, CA (US)

(72) Inventor: Kishore Kasichainula, Phoenix, AZ (US)

(73) Assignee: Intel Corporation, Santa Clara, CA (US)

(21) Appl. No.: 18/074,842

(22) Filed: Dec. 5, 2022

(51) Int. Cl. H04L 1/00

(52) U.S. Cl. CPC H04L 1/0042; H04L 1/0043; H04L 69/323

(57) ABSTRACT

A driver of an Ethernet controller may determine, based on an interrupt received from a PHY circuit coupled to the Ethernet controller, that a connection between the PHY circuit and a remote device was established using auto-negotiation over a physical communication medium. The driver may determine a speed of the connection. The driver may, based on a determination that the speed of the connection is not a first predetermined speed, enable auto-negotiation between the PHY circuit and the Ethernet controller to establish a link at a second speed that is different than the first predetermined speed.

### BACKGROUND

Time-sensitive networking (TSN) protocols provide extremely precise data transfer over a network. These networks include many heterogenous devices. One challenge in such a network is speed negotiation across different devices operating at different speeds. Conventionally, some speeds are available only when supported by hardware using defined auto-negotiation functions to allow devices operating at different speeds to advertise their capabilities and automatically configure themselves to operate a their maximum common negotiated speed. However, these solutions fail as new, often faster, speeds are added. For example, a device that can auto-negotiate to a predetermined speed may be unable to auto-negotiate to a speed that is faster than the predetermined speed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a logic flow 500 in accordance with one embodiment.

FIG. 6 illustrates an aspect of the subject matter in accordance with one embodiment.

### DETAILED DESCRIPTION

Embodiments disclosed herein provide scalable, secure, speed negotiation for time-sensitive networking devices. For example, a computing device may include hardware that supports various speeds, e.g., 2.5 gigabits (Gb) per second (Gbps), 10 Gbps, 100 Gbps, etc. However, because the physical sub-coding (PCS) layer of the device does not support backplane auto-negotiation defined in by clause 73 of the Institute of Electrical and Electronics Engineers (IEEE) 802.3 working group, the device is unable to auto-negotiate speeds greater than 1 Gb. As such, the faster supported speeds are not available for the auto-negotiation process. Embodiments disclosed herein may allow the device to be automatically configured to support the faster speeds using software that issues specific commands that can be used to configure the device to support these faster speeds.

Generally a driver of a network controller of the device may securely orchestrate programming of the various components of the local device to allow the device to operate at different speeds. Doing so provides a dynamic, plug-and-play solution for devices that include different hardware and support various speeds. Generally, when a far-end device (e.g., a remote device) is connected to a local device via a wired link, the devices perform auto-negotiation under clause 28 of IEEE 802.3 for a medium dependent interface (MDI) layer. Doing so allows one or more registers to be updated within a physical layer (PHY) component of the local device. The PHY component may then generate an interrupt to the platform through a general purpose input/output (GPIO) pin. The interrupt may be routed to the driver through a message signaled interrupt (MSI). The driver may then read the PHY status registers to identify the auto-negotiated speed (e.g., 1 Gbps.) Based on the detected speed, the driver may send a specific command (e.g., an inter-processor communication command, or “IPC1 command”) to a power management controller (PMC) of the local device. The driver may then read flexible interface adapter (FIA) lane ownership registers and platform configuration registers via one or more IPC1 commands to determine which lanes the network controller is assigned to and know which common lanes are available. Based on the determined information, the driver sends IPC1 commands to the PMC, which acts as a proxy for the driver to perform reads and/or writes of the registers, and ultimately configure the network controller of the local device to operate at different speeds (e.g., 2.5 Gbps, etc.) than the auto-negotiated speed. The different speeds may be faster and/or slower than the auto-negotiated speed.

Embodiments disclosed herein may provide scalable, dynamic, plug-and-play to automatically configure devices to operate at any data rate. Doing so may allow devices to support speeds that may not have been supported by the various auto-negotiation standards available when the devices were manufactured (e.g., devices that do not support one or more IEEE 802.3 auto-negotiation clauses). Conventionally, configuring these devices to support new speeds would require changes at the hardware (e.g., silicon) level. The embodiments disclosed herein may circumvent these limitations by securely implementing the speed negotiation through PMC IPC1 commands and the software driver of the network controller without requiring hardware changes. As another example, embodiments disclosed herein may allow PHY circuits that support faster speeds to be added to devices, and allow the devices to support these faster speeds.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

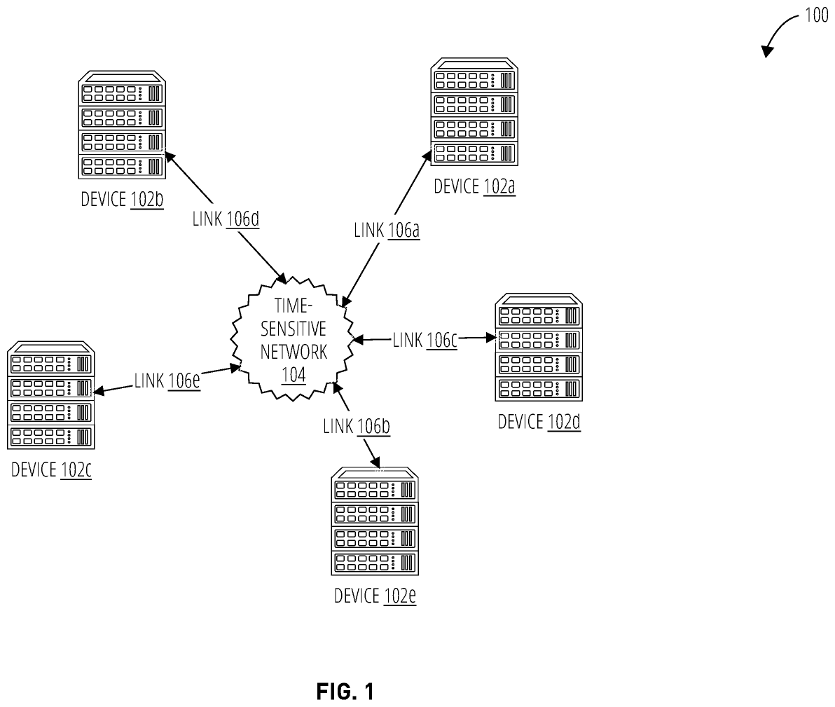

FIG. 1 illustrates an example system 100, according to an embodiment. As shown, the system 100 includes a plurality of devices, including devices 102a, 102b, 102c, 102d, and 102e. The devices 102a-102e are coupled via a time-sensitive network 104. The time-sensitive network 104 is generally configured to operate according to the time-sensitive networking (TSN) standards defined by the IEEE 802.1 working group. Furthermore, the time-sensitive network 104 is configured to operate according to the standards defined by the IEEE 802.3 working group, which includes auto-negotiation functions. Therefore, the devices 102a-102e are also configured to operate according to the standards defined by the IEEE 802.1 and 802.3 working groups. For example, the devices 102a-102e may use common time reference in the time-sensitive network 104 and may synchronize their clocks among each other to allow the devices 102a-102e to operate in unison and execute required operations at exactly the required point in time.

The devices 102a-102e are representative of any type of computing device, such as servers, workstations, desktop computers, networking devices (e.g., routers, switches, etc.), edge computing devices, smartphones, laptops, portable gaming devices, Internet of Things (IoT) devices, IoT group (IoTG) devices, and the like. For example, the devices 102a-102e may include IoT workload processing devices, e.g., IoT devices with compute resources, memory resources, input/output (I/O) resources, artificial intelligence (AI) resources, and/or security resources to process different workloads.

As shown, the devices 102a-102e are connected via one or more links 106a, 106b, 106c, 106d, and 106e. The links 106a-106e may include wired and/or wireless links. In some embodiments, one or more of the links 106a-106e may directly couple two devices 102a and 102b. For example, device 102a may be directly coupled to device 102b via a wired link, such as link 106a or link 106d. The wired links are representative of any physical transmission medium (also referred to as a “physical communication medium”), such as optical fibers, coaxial cables, copper cables, etc. Generally, when two devices are coupled via a wired link, the devices may engage in auto-negotiation under IEEE 802.3. However, depending on various factors, a given device may be able to support various speeds, but may not support auto-negotiation using each of these speeds. For example, when the platform PHY 210 of device 102a is connected to the platform PHY 210 of device 102b via a wired link, the devices may auto-negotiate to a 1 Gbps speed, even though each device is capable of faster speeds (e.g., 2.5 Gbps, etc.). As another example, the devices may negotiate to a 25 Gbps speed, even though a predetermined speed of 12.5 Gbps is desired. Therefore, a predetermined speed may be auto-negotiated, but a faster or slower predetermined speed may be desired.

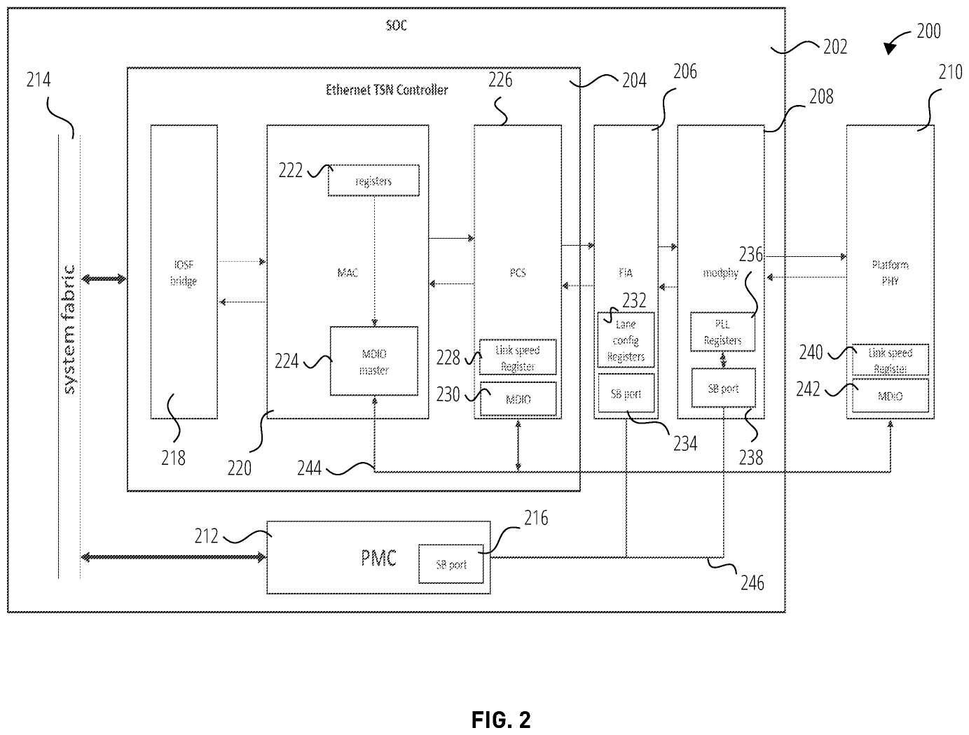

FIG. 2 is a schematic 200 illustrating components of one of the devices 102a-102e, according to an embodiment. As shown, each device 102a-102e includes a system-on-chip (SOC) 202. The SoC 202 includes one or more Ethernet controllers 204 (also referred to as a “network controller” or “network interface controller”), an FIA 206, a modphy 208, a platform PHY 210, a PMC 212, and a system fabric 214, each of which may be implemented in circuitry. The Ethernet controller 204 is generally configured to operate according to the time-sensitive networking standards defined by IEEE 802.1 working group and the standards defined by the IEEE 802.3 working group. The FIA 206 generally provides common interfaces (e.g., a plurality of sets of lanes, where each set of lanes includes a transmit lane, a receive lane, and a common lane) for communicating with peripheral devices (e.g., universal serial bus (USB) devices, Peripheral Component Interconnect (PCI) devices, Peripheral Component Interconnect-enhanced (PCIe) devices, Ethernet devices, etc.).

The modphy 208 is a physical layer component (e.g., the physical layer of the Open Systems Interconnection (OSI) model) that serializes data to be transmitted to a remote device via the platform PHY 210 and the time-sensitive network 104. In some embodiments, the modphy 208 is a Serial Gigabit Media Independent Interface (SGMII). The platform PHY 210 is a physical layer component that connects a medium access control (MAC) component 220 of the Ethernet controller 204 to a physical medium, such as one of the links 106a-106e. More generally, the platform PHY 210 includes processing circuitry for physical link layer processing of receive signals and/or transmit signals over various physical links (e.g., one of the links 106a-106e). The platform PHY 210 may further perform Ethernet encoding and/or decoding. In some embodiments, the platform PHY 210 is an external device that can be plugged in to the SoC 202 and/or removed from the SoC 202 (and a different platform PHY 210 may be connected to the SoC 202). Although depicted as external to the SoC 202, in some embodiments, the platform PHY 210 is a component of the SoC 202. The PMC 212 is a privileged component that generally manages the SoC 202 and has access to all components of the SoC 202. In some embodiments, the modphy 208 and the platform PHY 210 may engage in auto-negotiation according to IEEE 802.3 clause 37.

As shown, the Ethernet controller 204 includes an Intel® On-Chip System Fabric (IOSF) bridge 218, circuitry for the MAC 220, and circuitry for a PCS 226. The IOSF bridge 218 connects the Ethernet controller 204 to the system fabric 214, which provides a communication channel to other components of the SoC 202, such as one or more processors and system memory (not pictured). The MAC 220 performs operations at the data link layer of the OSI model. The PCS 226 performs operations at the physical layer of the OSI model, including encoding and/or decoding operations. In some embodiments, the PCS 226 performs auto-negotiation according to the IEEE 802.3 standard.

As shown, the MAC 220 includes one or more registers 222 and a medium independent I/O (MDIO) master 224. The MDIO master 224 may be a medium-independent interface, including a management data (I/O) interface. Generally, the MDIO master 224 is coupled to an MDIO bus 244, which allows the MDIO master 224 to communicate with the MDIO 230 of PCS 226 and/or the MDIO 242 of the platform PHY 210. The PCS 226 further includes one or more link speed registers 228, while the FIA 206 includes one or more lane configuration registers 232, the platform PHY 210 includes one or more link speed registers 240, and the modphy 208 includes one or more PLL registers 236.

As stated, the PMC 212 is communicably coupled to all components of the SoC 202 via the system fabric 214 and/or the sideband channel 246 (also referred to as a “sideband bus” or “out-of-band bus”). For example, as shown, the sideband channel 246 is a communication channel that allows a sideband (SB) port 216 of the PMC 212 to communicate with SB port 234 of FIA 206 and/or SB port 238 of modphy 208.

Various components of the SoC 202 (e.g., the modphy 208, platform PHY 210, and/or the PCS 226) may be compatible with clause 37 of the IEEE 802.3 standard, which supports auto-negotiation for speeds of 10 megabits per second (Mbps), 100 Mbps, or 1 Gbps. However, the modphy 208, platform PHY 210, and/or PCS 226 may be capable of operating at faster speeds, such as 2.5 Gbps, 10 Gbps, 25 Gbps, etc. Conventionally, systems desiring to operate at higher speeds (e.g., 2.5 Gbps, 10 Gbps, etc.) must support clause 73 of IEEE 802.3. However, the SoC 202 may not support clause 73. Conventionally, therefore, the various components of the SoC 202 cannot auto-negotiate speeds with remote devices that are not supported by clause 37 (e.g., speeds greater than 1 Gbps). However, embodiments disclosed herein may allow the SoC 202 to negotiate speeds with remote devices that are not supported by clause 37 using a combination of software and firmware of the SoC 202 (and without supporting clause 73).

Although example clauses are used as reference examples herein, embodiments are not limited to a particular clause of any particular standard. More generally, the disclosure applies equally to any device having one or more hardware capabilities defined by one or more clauses of one or more standards, where such clauses and/or standards are not supported by the firmware of the device. Furthermore, while a given speed may be used as a reference example herein, such speeds should not be considered limiting of the disclosure. More generally, the techniques of the disclosure may be extended to any speed so long as the encoders and/or decoders (e.g., the modphy 208) of the devices 102a-102e support backplane electrical signaling at such speeds. Any desired speeds may be faster or slower than a predetermined speed. The embodiments are not limited in these contexts.

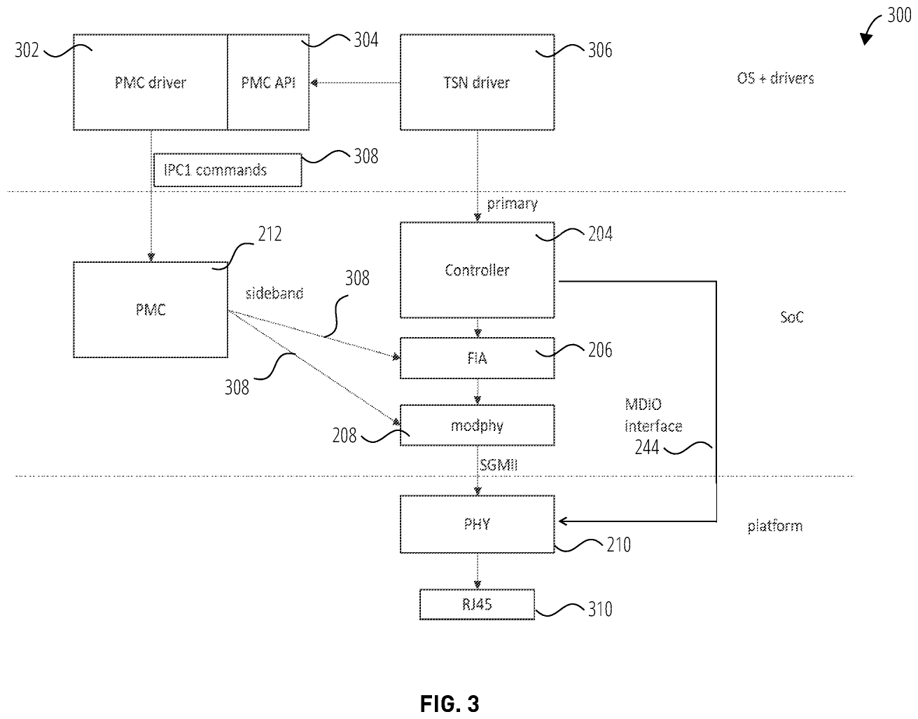

FIG. 3 is a schematic 300 illustrating techniques for scalable, secure, speed negotiation for time-sensitive networking devices, according to one embodiment. As shown, a PMC driver 302 may be a driver for the PMC 212 and may expose one or more application programming interfaces (APIs) 304. Similarly, the TSN driver 306 may be a driver for the Ethernet controller 204. The PMC driver 302 and TSN driver 306 may execute on a processor (not pictured) of the SoC 202 and within an operating system (OS) (not pictured). The PMC driver 302 and TSN driver 306 may allow the SoC 202 to negotiate speeds that exceed the speeds supported via auto-negotiation standards defined in IEEE 802.3 clause 37 while not supporting IEEE 802.3 clause 73. As another example, the PMC driver 302 and TSN driver 306 may allow the SoC 202 to negotiate speeds that are different (e.g., slower) than the speeds supported via auto-negotiation standards defined in IEEE 802.3 clause 37 while not supporting IEEE 802.3 clause 73.

Generally, instead of using hardware (e.g., the PCS 226) to negotiate speeds via the main data interface, embodiments disclosed herein negotiate speeds via the MDIO bus 244 between the platform PHY 210 and the Ethernet controller 204 using software and IPC1 commands sent by the PMC 212 via the sideband channel 246. Generally, when a device such as device 102a is booted, the OS of the device 102a may load the PMC driver 302 and the TSN driver 306. The TSN driver 306 may disable one or more auto-negotiation bits in one or more registers of the platform PHY 210, such as the link speed registers 240. Doing so may disable SGMII auto-negotiation between the platform PHY 210 and the PCS 226, as the auto-negotiation may not result in desired speeds (e.g., a predetermined speed). Therefore, in some embodiments, the auto-negotiation may be disabled via one or more bits of the link speed registers 228 of the PCS 226. When a far-end (e.g., a remote device, such as device 102b) is connected to the platform PHY 210 via a wired link, the platform PHY 210 may perform auto-negotiation with the remote device using IEEE 802.3 clause 28 functions.

When the clause 28 auto-negotiation (e.g., MDI layer auto-negotiation) between the devices is complete, the status of the auto-negotiation is written to the link speed registers 240 of the platform PHY 210. The platform PHY 210 may then generate an interrupt through one or more GPIO pins (e.g., the RGMII INT pin). The interrupt may specify a connection status of the link, such as link up or link down, a link speed, whether the link is full duplex or half duplex, etc. The interrupt may be sent to the TSN driver 306, e.g., through an MSI. As another example, instead of receiving the interrupt, the TSN driver 306 may poll the platform PHY 210 for the connection status information. The TSN driver 306 may then read the link speed registers 240 of the platform PHY 210 via the MDIO bus 244 to identify the speeds negotiated using clause 28 auto-negotiation. The TSN driver 306 may further read the lane config registers 232 of the FIA 206 using one or more IPC1 commands 308. For example, the TSN driver 306 may transmit one or more API calls to the PMC APIs 304 specifying to read the lane config registers 232 and the PLL registers 236 of the modphy 208. The PMC APIs 304 may pass the received API call to the PMC driver 302, which generates one or more IPC1 commands 308. The PMC 212 may then read the lane config registers 232 and the PLL registers 236 by transmitting the IPC1 commands 308 to the FIA 206 and the modphy 208 via the sideband channel 246. Therefore, the PMC 212 performs proxy reads (and proxy writes) on behalf of the TSN driver 306, which cannot directly access certain system components (e.g., the FIA 206 including lane config registers 232 and the modphy 208 including PLL registers 236). The lane config registers 232 and PLL registers 236 generally specify ownership of different lanes. For example, a set of lanes may be dedicated to each of the Ethernet controllers 204 of the SoC 202. The common lane of each set must be available to increase the data rate to the desired speed, e.g., 2.5 Gbps. The PMC 212 may receive the data from the lane config registers 232 and/or the PLL registers 236, and provide the data to the TSN driver 306, e.g., via one or more API calls.

The TSN driver 306 may then identify a different speed that is supported by the hardware, but not supported by the firmware of the SoC 202. For example, the TSN driver 306 may identify a 2.5 Gbps speed, greater than the negotiated 1 Gbps speed. The TSN driver 306 may then transmit one or more API calls to the PMC APIs 304 indicating the identified greater speed (e.g., 2.5 Gbps) and the lane ownership information. The PMC APIs 304 may provide the API calls to the PMC driver 302. The PMC driver 302 may then generate one or more IPC1 commands 308 reflecting the speed specified and lane ownership in the API call. The PMC 212 may then transmit the IPC1 command 308 to the FIA 206 via sideband channel 246, thereby writing values to the lane config registers 232 to reflect the 2.5 Gbps speed and writing values to the PLL registers 236 to reflect the allocation of one or more sets of lanes to the Ethernet controller 204 at the 2.5 Gbps speed. For example, doing so may configure the lanes to operate at the desired speed, e.g., 2.5 Gbps.

Once the lane config registers 232 are programmed, the TSN driver 306 may configure the Ethernet controller 204. Generally, if the link speed is 1 Gbps or below, the TSN driver 306 may enable an SGMII auto-negotiation bit in a register of the PCS 226, where the SGMII auto-negotiation occurs between the platform PHY 210 and the MAC 220. Doing so initiates the auto-negotiation process between the PCS 226 of the MAC 220 and the platform PHY 210. If the link speed is 2.5 Gbps or greater, the TSN driver 306 disables the auto-negotiation bit in the PCS 226 and sets the PCS link speed to 2.5 Gbps in the link speed register 228 of the PCS 226, e.g., via the MDIO bus 244.

The TSN driver 306 may then configure registers 222 in the MAC 220 and gasket registers for PHY data lane initiation. The PCS 226 may initiate auto-negotiation if the link speed registers 228 indicate the speed is 1 Gbps. In such an example, the PCS generates an interrupt when the auto-negotiation is complete. The TSN driver 306 may then read the link speed register 228, e.g., via the MDIO bus 244. The TSN driver 306 may then program the registers 222 of the MAC 220 to reflect the speed read from the link speed register 228. This may cause the MAC 220 to enter into a valid, operational state, allowing data transfer to occur via the port 310. If, however, the link speed registers 228 indicate the link speed after auto-negotiation is 2.5 Gbps, the TSN driver 306 writes an indication of a 1 Gbps speed to the registers 222 of the MAC 220, which causes the MAC 220 to enter a valid operational state without engaging in auto-negotiation between the PCS 226 and the platform PHY 210.

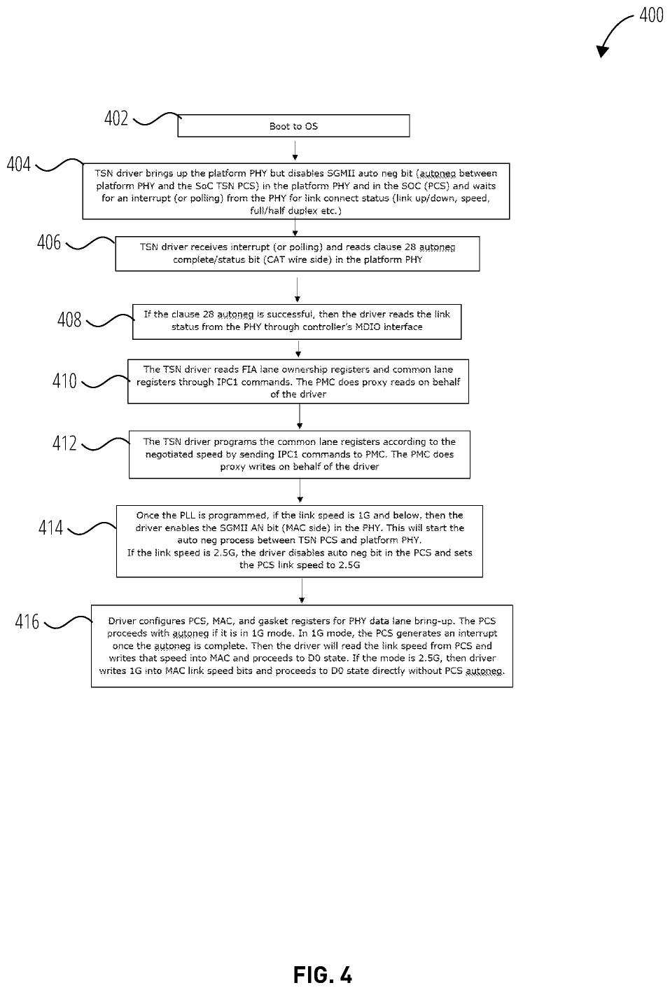

FIG. 4 illustrates an embodiment of a logic flow 400. The logic flow 400 may be representative of some or all of the operations executed by one or more embodiments described herein. For example, the logic flow 400 may include some or all of the operations to provide scalable, secure, speed negotiation for time-sensitive networking devices, according to one embodiment. Embodiments are not limited in this context.

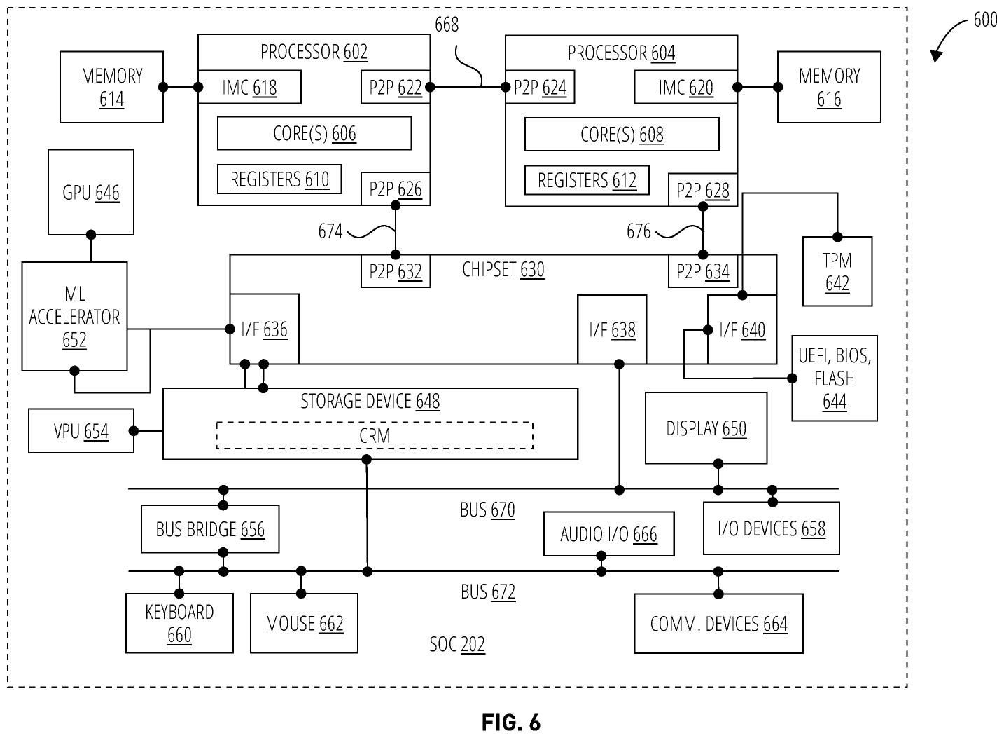

At block 402, a device such as one of the devices 102a-102e may be booted to an operating system. Doing so may cause the PMC drivers 302 and the TSN drivers 306 to load, e.g., execute on a processor such as processors 602, 604 of FIG. 6. At block 404, the TSN driver 306 brings up (e.g., configures) the platform PHY 210. Doing so may include disabling an auto-negotiation bit in one or more registers 240 of the platform PHY 210. For example, the auto-negotiation bit may correspond to SGMII auto-negotiation between the platform PHY 210 and the PCS 226. The TSN driver 306 may receive an indication that a connection is to be established (e.g., to another one of devices 102a-102e) via clause 28 auto-negotiation between the devices. The indication may be received based on an interrupt received from the platform

PHY 210 and/or polling the platform PHY 210. The interrupt may specify a connection status, such as link up or link down, a link speed, whether the link is full duplex or half duplex, etc.

At block 406, the TSN driver 306 receives the interrupt and reads the link speed registers 240 of the platform PHY 210 via the MDIO bus 244 to identify the speeds negotiated using clause 28 auto-negotiation. At block 408, if the lane config registers 232 indicate the clause 28 auto-negotiation is successful, the TSN driver 306 reads the link speed registers 240 of the platform PHY 210 via the MDIO bus 244.

At block 410, the TSN driver 306 reads the lane config registers 232 of the FIA 206 and the PLL registers 236 of the modphy 208 via one or more IPC1 commands 308 as described above. As stated, the TSN driver 306 may generate one or more API calls to the PMC APIs 304, which cause the PMC driver 302 to send, via the PMC 212, one or more IPC1 commands 308 to read the requested data. At block 412, the TSN driver 306 programs the lane config registers 232 of the FIA 206 and the PLL registers 236 of the modphy 208 using one or more IPC1 commands 308 as described above, e.g., using the PMC 212 as a proxy to write the data using one or more IPC1 commands 308 via the sideband channel 246. At block 414, the TSN driver 306 enables the SGMII auto-negotiation between the PCS 226 and the platform PHY 210 if the link speed is 1 Gbps or lower (e.g., based on the speeds specified in the link speed registers 228). Doing so starts the auto-negotiation between the PCS 226 and the platform PHY 210. If, however, the link speed registers 228 indicate the speed is 2.5 Gbps, the TSN driver 306 disables the SGMII auto-negotiation between the PCS 226 and the platform PHY 210 and sets the link speed register 228 of the PCS 226 to reflect the 2.5 Gbps speed.

At block 416, the TSN driver 306 configures the PCS 226, MAC 220, and gasket registers to bring up the data lane for the platform PHY 210. Generally, the PCS 226 may proceed with auto-negotiation if the link speed registers 228 indicate the speed is 1 Gbps. Once the auto-negotiation is complete, the PCS 226 may generate an interrupt that is sent to the TSN driver 306. The TSN driver 306 then reads the link speed register 228 of the PCS 226 and writes the speed from the link speed register 228 to the registers 222 of the MAC, which proceeds to operate in a valid state. If, however, the link speed register 228 indicates the speed is 2.5 Gbps, the driver writes a speed of 1 Gbps to the registers 222 of the MAC 220, which proceeds to the valid operational state without performing SGMII auto-negotiation.

FIG. 4 illustrates an embodiment of a logic flow 500. The logic flow 500 may be representative of some or all of the operations executed by one or more embodiments described herein. For example, the logic flow 500 may include some or all of the operations to provide scalable, secure, speed negotiation for time-sensitive networking devices, according to one embodiment. Embodiments are not limited in this context.

In block 502, logic flow 500 determines, by a driver (e.g. TSN driver 306) of an Ethernet controller (e.g., the Ethernet controller 204) of a system on a chip (SoC) (e.g., the SoC 202) based on an interrupt received from a PHY circuit (e.g., the platform PHY 210) coupled to the Ethernet controller, that a connection between the PHY circuit and a remote device was established using auto-negotiation over a physical communication medium. In block 504, logic flow 500 determines, by the driver, a speed of the connection. In block 506, logic flow 500 based on a determination that the speed of the connection is not a first predetermined speed, enables, by the driver, auto-negotiation between the PHY circuit and the Ethernet controller to establish a link at a second speed that is different than the first predetermined speed. For example, the second speed may be faster than the first predetermined speed. As another example, the second speed may be slower than the first predetermined speed.

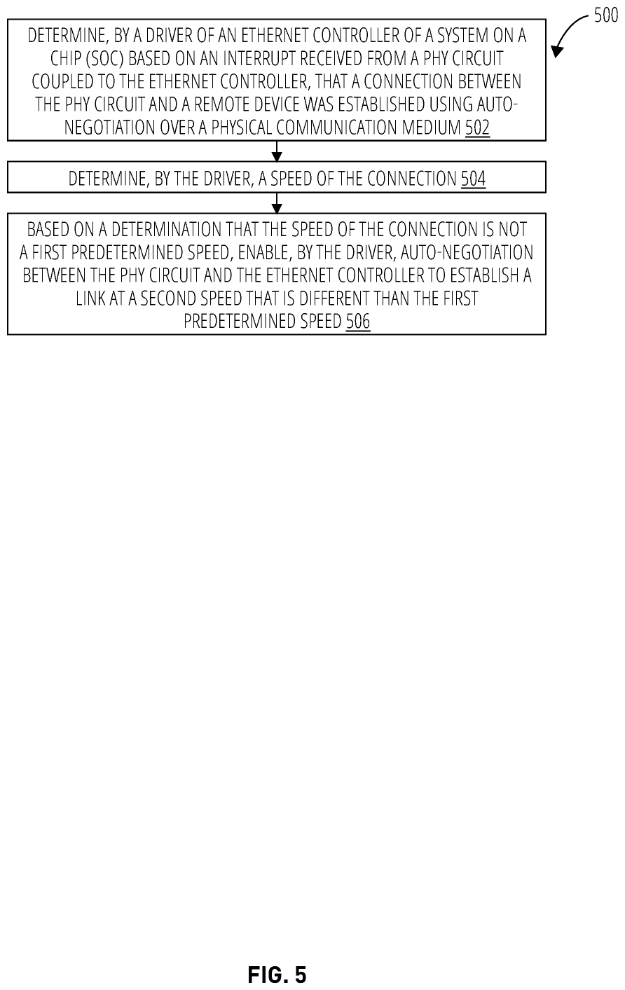

FIG. 6 illustrates an embodiment of a system 600. System 600 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 600 may have a single processor with one core or more than one processor. Note that the term “processor” refers to a processor with a single core or a processor package with multiple processor cores. In at least one embodiment, the computing system 600 is representative of the components of the devices 102a-102e. More generally, the computing system 600 is configured to include all logic, systems, logic flows, methods, apparatuses, circuitry, and functionality described herein with reference to FIGS. 1-5.

As used in this application, the terms “system” and “component” and “module” are intended to refer to a computer-related entity, either hardware, a combination of hardware and software, software, or software in execution, examples of which are provided by the exemplary system 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 6, system 600 comprises a SoC 202 for mounting platform components. SoC 202 is a point-to-point (P2P) interconnect platform that includes a first processor 602 and a second processor 604 coupled via a point-to-point interconnect 668 such as an Ultra Path Interconnect (UPI). In other embodiments, the system 600 may be of another bus architecture, such as a multi-drop bus. Furthermore, each of processor 602 and processor 604 may be processor packages with multiple processor cores including core(s) 606 and core(s) 608, respectively. While the system 600 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the SoC 202 with certain components mounted such as the processor 602 and chipset 630. Some platforms may include additional components and some platforms may only include sockets to mount the processors and/or the chipset. Furthermore, some platforms may not have sockets (e.g. SoC, or the like). Although depicted as a SoC 202, one or more of the components of the SoC 202 may also be included in a single die package, a multi-chip module (MCM), a multi-die package, a chiplet, a bridge, and/or an interposer. Therefore, embodiments are not limited to an SoC.

The processor 602 and processor 604 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 602 and/or processor 604. Additionally, the processor 602 need not be identical to processor 604.

Processor 602 includes an integrated memory controller (IMC) 618 and point-to-point (P2P) interface 622 and P2P interface 626. Similarly, the processor 604 includes an IMC 620 as well as P2P interface 624 and P2P interface 628. IMC 618 and IMC 620 couple the processors processor 602 and processor 604, respectively, to respective memories (e.g., memory 614 and memory 616). Memory 614 and memory 616 may be portions of the main memory (e.g., a dynamic random-access memory (DRAM)) for the platform such as double data rate type 3 (DDR3) or type 4 (DDR4) synchronous DRAM (SDRAM). In the present embodiment, the memory 614 and the memory 616 locally attach to the respective processors (i.e., processor 602 and processor 604). In other embodiments, the main memory may couple with the processors via a bus and shared memory hub. Processor 602 includes registers 610 and processor 604 includes registers 612.

System 600 includes chipset 630 coupled to processor 602 and processor 604. Furthermore, chipset 630 can be coupled to storage device 648, for example, via an interface (I/F) 636. The I/F 636 may be, for example, a Peripheral Component Interconnect-enhanced (PCIe) interface, a Compute Express Link® (CXL) interface, or a Universal Chiplet Interconnect Express (UCIe) interface. Storage device 648 can store instructions executable by circuitry of system 600 (e.g., processor 602, processor 604, GPU 646, ML accelerator 652, vision processing unit 654, or the like). For example, storage device 648 can store instructions for PMC driver 302, TSN driver 306, PMC APIs 304, and the like.

Processor 602 couples to the chipset 630 via P2P interface 626 and P2P 632 while processor 604 couples to the chipset 630 via P2P interface 628 and P2P 634. Direct media interface (DMI) 674 and DMI 676 may couple the P2P interface 626 and the P2P 632 and the P2P interface 628 and P2P 634, respectively. DMI 674 and DMI 676 may be a high-speed interconnect that facilitates, e.g., eight Giga Transfers per second (GT/s) such as DMI 3.0. In other embodiments, the processor 602 and processor 604 may interconnect via a bus.

The chipset 630 may comprise a controller hub such as a platform controller hub (PCH). The chipset 630 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 630 may comprise more than one controller hub such as a chipset with a memory controller hub, a graphics controller hub, and an input/output (I/O) controller hub.

In the depicted example, chipset 630 couples with a trusted platform module (TPM) 642 and UEFI, BIOS, FLASH circuitry 644 via I/F 640. The TPM 642 is a dedicated microcontroller designed to secure hardware by integrating cryptographic keys into devices. The UEFI, BIOS, FLASH circuitry 644 may provide pre-boot code.

Furthermore, chipset 630 includes the I/F 636 to couple chipset 630 with a high-performance graphics engine, such as, graphics processing circuitry or a graphics processing unit (GPU) 646. In other embodiments, the system 600 may include a flexible display interface (FDI) (not shown) between the processor 602 and/or the processor 604 and the chipset 630. The FDI interconnects a graphics processor core in one or more of processor 602 and/or processor 604 with the chipset 630.

Additionally, ML accelerator 652 and/or vision processing unit 654 can be coupled to chipset 630 via I/F 636. The ML accelerator 652 is representative of any type of accelerator device, such as a cryptographic accelerator, cryptographic co-processor, an offload engine, and the like. The ML accelerator 652 may be a device including circuitry to accelerate data encryption and/or data compression. The ML accelerator 652 can also include circuitry arranged to execute machine learning (ML) related operations (e.g., training, inference, etc.) for ML models. Generally, the ML accelerator 652 may be specially designed to perform computationally intensive operations, such as cryptographic operations and/or compression operations, in a manner that is far more efficient than when performed by the processor 602 or processor 604. Because the load of the system 600 may include cryptographic and/or compression operations, the ML accelerator 652 can greatly increase performance of the system 600 for these operations.

Various I/O devices 658 and display 650 couple to the bus 670, along with a bus bridge 656 which couples the bus 670 to a second bus 672 and an I/F 638 that connects the bus 670 with the chipset 630. In one embodiment, the second bus 672 may be a low pin count (LPC) bus. Various devices may couple to the second bus 672 including, for example, a keyboard 660, a mouse 662 and communication devices 664.

Furthermore, an audio I/O 666 may couple to second bus 672. Many of the I/O devices 658 and communication devices 664 may reside on the SoC 202 while the keyboard 660 and the mouse 662 may be add-on peripherals. In other embodiments, some or all the I/O devices 658 and communication devices 664 are add-on peripherals and do not reside on the SoC 202. The I/O devices 658 and/or the communication devices 664 may include the Ethernet controller 204, the FIA 206, modphy 208, and the platform PHY 210, each not depicted in FIG. 6 for the sake of clarity. Although not depicted in FIG. 6, as stated, the SoC 202 further includes the PMC 212, the sideband channel 246, and the MDIO bus 244.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes a non-transitory computer-readable storage medium, the computer-readable storage medium including instructions that when executed by a processor, cause the processor to: determine, by a driver of an Ethernet controller based on an interrupt received from a PHY circuit coupled to the Ethernet controller, that a connection between the PHY circuit and a remote device was established using auto-negotiation over a physical communication medium; determine, by the driver, a speed of the connection; and based on a determination that the speed of the connection is not a first predetermined speed, enable, by the driver, auto-negotiation between the PHY circuit and the Ethernet controller to establish a link at a second speed that is different than the first predetermined speed.

Example 2 includes the subject matter of example 1, wherein the instructions further cause the processor to: store, by the driver, an indication of the second speed in a media access control (MAC) circuit of the Ethernet controller.

Example 3 includes the subject matter of example 1, wherein the instructions further cause the processor to, prior to the determination that the connection was established: disable, by the driver, an auto-negotiation bit of the PHY circuit; and receive the interrupt.

Example 4 includes the subject matter of example 1, wherein the instructions further cause the processor to: determine, by the driver, that a set of lanes of a flexible interface adapter (FIA) coupled to the Ethernet controller are allocated to the Ethernet controller; and program, by the driver, lane configuration registers of the FIA based on the speed of the connection.

Example 5 includes the subject matter of example 1, wherein the instructions further cause the processor to: based on a determination that the speed of the connection exceeds the first predetermined speed: disable, by the driver, auto-negotiation between the PHY circuit and the Ethernet controller; and store, by the driver, an indication of the speed of the connection in a physical coding sublayer (PCS) circuit of the Ethernet controller.

Example 6 includes the subject matter of example 5, wherein the instructions further cause the processor to: receive, by the driver from the PCS circuit, another interrupt; read, by the driver and in the PCS circuit, the second speed of the link; and store, by the driver in a media access control (MAC) circuit of the Ethernet controller, an indication of the second speed read from the PCS circuit.

Example 7 includes the subject matter of example 1, wherein the Ethernet controller is to comprise a time-sensitive networking (TSN) Ethernet controller, wherein the instructions further cause the processor to: based on a determination that the second speed does not exceed the first predetermined speed, perform the auto-negotiation between the PHY circuit and the TSN Ethernet controller.

Example 8 includes an apparatus, comprising: an Ethernet controller; a processor; and a memory storing instructions that, when executed by the processor, cause the processor to: determine, by a driver of the Ethernet controller based on an interrupt received from a PHY circuit coupled to the Ethernet controller, that a connection between the PHY circuit and a remote device was established using auto-negotiation over a physical communication medium; determine, by the driver, a speed of the connection; and based on a determination that the speed of the connection is not a first predetermined speed, enable, by the driver, auto-negotiation between the PHY circuit and the Ethernet controller to establish a link at a second speed that is different than the first predetermined speed.

Example 9 includes the subject matter of example 8, wherein the instructions further cause the processor to: store, by the driver, an indication of the second speed in a media access control (MAC) circuit of the Ethernet controller.

Example 10 includes the subject matter of example 8, wherein the instructions further cause the processor to, prior to the determination that the connection was established: disable, by the driver, an auto-negotiation bit of the PHY circuit; and receive the interrupt.

Example 11 includes the subject matter of example 8, wherein the instructions further cause the processor to: determine, by the driver, that a set of lanes of a flexible interface adapter (FIA) coupled to the Ethernet controller are allocated to the Ethernet controller; and program, by the driver, lane configuration registers of the FIA based on the speed of the connection.

Example 12 includes the subject matter of example 11, further comprising a power management controller (PMC), wherein a driver of the PMC receives an application programming interface (API) call from the driver of the Ethernet controller specifying to read a plurality of registers of the FIA, wherein the PMC reads the plurality of registers of the FIA via a sideband channel and one or more inter-processor communication commands.

Example 13 includes the subject matter of example 12, wherein the driver of the Ethernet controller programs the lane configuration registers by transmitting another API call to the driver of the PMC, the another API call comprising an indication to program the lane configuration registers, wherein the PMC programs the lane configuration registers via the sideband channel and another one or more inter-processor communication commands.

Example 14 includes the subject matter of example 8, wherein the driver reads a register of the PHY circuit to determine the speed of the connection via a medium independent I/O (MDIO) bus, wherein the Ethernet controller is a time-sensitive networking (TSN) Ethernet controller compatible with standards of the Institute of Electrical and Electronics Engineers (IEEE) 802.3 working group and the IEEE 802.1 working group.

Example 15 includes a method, comprising: determining, by a driver of an Ethernet controller of a system on a chip (SoC) based on an interrupt received from a PHY circuit coupled to the Ethernet controller, that a connection between the PHY circuit and a remote device was established using auto-negotiation over a physical communication medium; determining, by the driver, a speed of the connection; and based on a determination that the speed of the connection is not a first predetermined speed, enabling, by the driver, auto-negotiation between the PHY circuit and the Ethernet controller to establish a link at a second speed that is different than the first predetermined speed.

Example 16 includes the subject matter of example 15, wherein the Ethernet controller is a time-sensitive networking (TSN) Ethernet controller compatible with standards of the Institute of Electrical and Electronics Engineers (IEEE) 802.3 working group and the IEEE 802.1 working group, the method further comprising: storing, by the driver, an indication of the second speed in a media access control (MAC) circuit of the TSN Ethernet controller.

Example 17 includes the subject matter of example 15, further comprising prior to determining that the connection was established: disabling, by the driver, an auto-negotiation bit of the PHY circuit; and receiving the interrupt.

Example 18 includes the subject matter of example 15, further comprising: determining, by the driver, that a set of lanes of a flexible interface adapter (FIA) coupled to the Ethernet controller are allocated to the Ethernet controller; and programming, by the driver, lane configuration registers of the FIA based on the speed of the connection.

Example 19 includes the subject matter of example 18, wherein the SoC comprises a power management controller (PMC), wherein a driver of the PMC receives an API call from the driver of the Ethernet controller indicating to read a plurality of registers of the FIA, wherein the PMC reads the plurality of registers of the FIA via a sideband channel and one or more inter-processor communication commands.

Example 20 includes the subject matter of example 19, wherein the driver of the Ethernet controller programs the lane configuration registers by transmitting another API call to the driver of the PMC, the another API call comprising an indication to program the lane configuration registers, wherein the PMC programs the lane configuration registers via the sideband channel and another one or more inter-processor communication commands.

Example 21 includes the subject matter of example 15, further comprising based on a determination that the speed of the connection exceeds the first predetermined speed: disabling, by the driver, auto-negotiation between the PHY circuit and the Ethernet controller; and storing, by the driver, an indication of the speed of the connection in a physical coding sublayer (PCS) circuit of the Ethernet controller.

Example 22 includes the subject matter of example 15, wherein the driver reads a register of the PHY circuit to determine the speed of the connection via a medium independent I/O (MDIO) bus, wherein the Ethernet controller is a time-sensitive networking (TSN) Ethernet controller compatible with standards of the Institute of Electrical and Electronics Engineers (IEEE) 802.3 working group and the IEEE 802.1 working group

Example 23 includes an apparatus, comprising: means for determining, by a driver of an Ethernet controller based on an interrupt received from a PHY circuit coupled to the Ethernet controller, that a connection between the PHY circuit and a remote device was established using auto-negotiation over a physical communication medium; means for determining, by the driver, a speed of the connection; and means for, based on a determination that the speed of the connection is not a first predetermined speed, enabling, by the driver, auto-negotiation between the PHY circuit and the Ethernet controller to establish a link at a second speed that is different than the first predetermined speed.

Example 24 includes the subject matter of example 23, further comprising: means for storing, by the driver, an indication of the second speed in a media access control (MAC) circuit of the Ethernet controller.

Example 25 includes the subject matter of example 23, further comprising, prior to the determination that the connection was established: means for disabling, by the driver, an auto-negotiation bit of the PHY circuit; and means for receiving the interrupt.

Example 26 includes the subject matter of example 23, further comprising: means for determining, by the driver, that a set of lanes of a flexible interface adapter (FIA) coupled to the Ethernet controller are allocated to the Ethernet controller; and means for programming, by the driver, lane configuration registers of the FIA based on the speed of the connection.

Example 27 includes the subject matter of example 26, further comprising: means for a power management controller (PMC), wherein a driver of the PMC receives an application programming interface (API) call from the driver of the Ethernet controller specifying to read a plurality of registers of the FIA, wherein the PMC reads the plurality of registers of the FIA via a sideband channel and one or more inter-processor communication commands.

Example 28 includes the subject matter of example 27, wherein the driver of the Ethernet controller programs the lane configuration registers by transmitting another API call to the driver of the PMC, the another API call comprising an indication to program the lane configuration registers, wherein the PMC programs the lane configuration registers via the sideband channel and another one or more inter-processor communication commands.

Example 29 includes the subject matter of example 23, wherein the driver reads a register of the PHY circuit to determine the speed of the connection via a medium independent I/O (MDIO) bus, wherein the Ethernet controller is a time-sensitive networking (TSN) Ethernet controller compatible with standards of the Institute of Electrical and Electronics Engineers (IEEE) 802.3 working group and the IEEE 802.1 working group.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A non-transitory computer-readable storage medium, the computer-readable storage medium including instructions that when executed by a processor, cause the processor to:
determine, by a driver of an Ethernet controller based on an interrupt received from a PHY circuit coupled to the Ethernet controller, that a connection between the PHY circuit and a remote device was established using auto-negotiation over a physical communication medium;
determine, by the driver, a speed of the connection; and
based on a determination that the speed of the connection is not a first predetermined speed, enable, by the driver, auto-negotiation between the PHY circuit and the Ethernet controller to establish a link at a second speed that is different than the first predetermined speed.

2. The computer-readable storage medium of claim 1, wherein the instructions further cause the processor to:
store, by the driver, an indication of the second speed in a media access control (MAC) circuit of the Ethernet controller.

3. The computer-readable storage medium of claim 1, wherein the instructions further cause the processor to, prior to the determination that the connection was established:
disable, by the driver, an auto-negotiation bit of the PHY circuit; and
receive the interrupt.

4. The computer-readable storage medium of claim 1, wherein the instructions further cause the processor to:
determine, by the driver, that a set of lanes of a flexible interface adapter (FIA) coupled to the Ethernet controller are allocated to the Ethernet controller; and
program, by the driver, lane configuration registers of the FIA based on the speed of the connection.

5. The computer-readable storage medium of claim 1, wherein the instructions further cause the processor to:
based on a determination that the speed of the connection exceeds the first predetermined speed:
disable, by the driver, auto-negotiation between the PHY circuit and the Ethernet controller; and
store, by the driver, an indication of the speed of the connection in a physical coding sublayer (PCS) circuit of the Ethernet controller.

6. The computer-readable storage medium of claim 5, wherein the instructions further cause the processor to:
receive, by the driver from the PCS circuit, another interrupt;
read, by the driver and in the PCS circuit, the second speed of the link; and
store, by the driver in a media access control (MAC) circuit of the Ethernet controller, an indication of the second speed read from the PCS circuit.

7. The computer-readable storage medium of claim 1, wherein the Ethernet controller is to comprise a time-sensitive networking (TSN) Ethernet controller, wherein the instructions further cause the processor to:
based on a determination that the second speed does not exceed the first predetermined speed, perform the auto-negotiation between the PHY circuit and the TSN Ethernet controller.

8. An apparatus, comprising:
an Ethernet controller;
a processor; and
a memory storing instructions that, when executed by the processor, cause the processor to:
determine, by a driver of the Ethernet controller based on an interrupt received from a PHY circuit coupled to the Ethernet controller, that a connection between the PHY circuit and a remote device was established using auto-negotiation over a physical communication medium;
determine, by the driver, a speed of the connection; and
based on a determination that the speed of the connection is not a first predetermined speed, enable, by the driver, auto-negotiation between the PHY circuit and the Ethernet controller to establish a link at a second speed that is different than the first predetermined speed.

9. The apparatus of claim 8, wherein the instructions further cause the processor to:
store, by the driver, an indication of the second speed in a media access control (MAC) circuit of the Ethernet controller.

10. The apparatus of claim 8, wherein the instructions further cause the processor to, prior to the determination that the connection was established:
disable, by the driver, an auto-negotiation bit of the PHY circuit; and
receive the interrupt.

11. The apparatus of claim 8, wherein the instructions further cause the processor to:
determine, by the driver, that a set of lanes of a flexible interface adapter (FIA) coupled to the Ethernet controller are allocated to the Ethernet controller; and
program, by the driver, lane configuration registers of the FIA based on the speed of the connection.

12. The apparatus of claim 11, further comprising a power management controller (PMC), wherein a driver of the PMC receives an application programming interface (API) call from the driver of the Ethernet controller specifying to read a plurality of registers of the FIA, wherein the PMC reads the plurality of registers of the FIA via a sideband channel and one or more inter-processor communication commands.

13. The apparatus of claim 12, wherein the driver of the Ethernet controller programs the lane configuration registers by transmitting another API call to the driver of the PMC, the another API call comprising an indication to program the lane configuration registers, wherein the PMC programs the lane configuration registers via the sideband channel and another one or more inter-processor communication commands.

14. The apparatus of claim 8, wherein the driver reads a register of the PHY circuit to determine the speed of the connection via a medium independent I/O (MDIO) bus, wherein the Ethernet controller is a time-sensitive networking (TSN) Ethernet controller compatible with standards of the Institute of Electrical and Electronics Engineers (IEEE) 802.3 working group and the IEEE 802.1 working group.

15. A method, comprising:
determining, by a driver of an Ethernet controller of a system on a chip (SoC) based on an interrupt received from a PHY circuit coupled to the Ethernet controller, that a connection between the PHY circuit and a remote device was established using auto-negotiation over a physical communication medium;
determining, by the driver, a speed of the connection; and
based on a determination that the speed of the connection is not a first predetermined speed, enabling, by the driver, auto-negotiation between the PHY circuit and the Ethernet controller to establish a link at a second speed that is different than the first predetermined speed.

16. The method of claim 15, wherein the Ethernet controller is a time-sensitive networking (TSN) Ethernet controller compatible with standards of the Institute of Electrical and Electronics Engineers (IEEE) 802.3 working group and the IEEE 802.1 working group, the method further comprising:
storing, by the driver, an indication of the second speed in a media access control (MAC) circuit of the TSN Ethernet controller.

17. The method of claim 15, further comprising prior to determining that the connection was established:
disabling, by the driver, an auto-negotiation bit of the PHY circuit; and
receiving the interrupt.

18. The method of claim 15, further comprising:
determining, by the driver, that a set of lanes of a flexible interface adapter (FIA) coupled to the Ethernet controller are allocated to the Ethernet controller; and
programming, by the driver, lane configuration registers of the FIA based on the speed of the connection.

19. The method of claim 18, wherein the SoC comprises a power management controller (PMC), wherein a driver of the PMC receives an API call from the driver of the Ethernet controller indicating to read a plurality of registers of the FIA, wherein the PMC reads the plurality of registers of the FIA via a sideband channel and one or more inter-processor communication commands.

20. The method of claim 15, further comprising based on a determination that the speed of the connection exceeds the first predetermined speed:
disabling, by the driver, auto-negotiation between the PHY circuit and the Ethernet controller; and
storing, by the driver, an indication of the speed of the connection in a physical coding sublayer (PCS) circuit of the Ethernet controller.
